(19) United States
(12) Patent Application Publication
(10) Pub. No.: US 2003/0056181 A1
(43) Pub. Date: Mar. 20, 2003

(54) System and method for displaying spreadsheet cell formulas in two dimensional mathematical notation

(76) Inventor: Sharad M. Marathe, Rockford, IL (US)

Correspondence Address: LEYDIG VOIT & MAYER, LTD, 6815 WEAVER ROAD, ROCKFORD, IL, 61114-8018, US

(21) Appl. No.: 10/221,967

(22) PCT Filed: Mar. 19, 2001
(86) PCT No.: PCT/US01/08698

(51) Int. Cl. G06F 17/21

(52) U.S. Cl. 715/538

(57) ABSTRACT

Presented is a system that takes a formula in single line form in spreadsheets and other programming environments and converts it into two dimensional mathematical notation. The conversion takes place at the level of a single line as entered in the programming environment or at the level of multiple lines by recursively substituting variables to build up a formula which has been sub-divided. Symbolic names are assigned to formulas and input values used by formulas to give formulas more meaning when the formulas are being debugged. Complicated formulas that are too complex for the programming environment to handle, too difficult to maintain or extend in the programming environment, or too time-consuming for the programming environment to execute are solved in an independent module capable of solving the complicated formulas and the solution is linked to the programming environment.

The international application was published under PCT Article 21(2) in English.

### FIELD OF THE INVENTION

The present invention relates generally to spreadsheet development tools, and more particularly relates to equation development and debugging tools for spreadsheets.

### BACKGROUND OF THE INVENTION

Spreadsheets and programming languages such as FORTRAN, BASIC, Visual Basic, VBA, Pascal, C, JAVA, etc. are being used by millions of users. These programming environments provide a convenient means of setting up a variety of calculations. These calculations are based upon equations or formulas, which are entered at the level of a single line of code. For example, a simple equation describing an elliptic paraboloid in single line form is written as “xˆ 2/aˆ 2+yˆ 2/bˆ 2=cz” and an equation with “real” variable names is written as “balance=payment*(1-(1+rate)ˆ (month−term))/rate”. These equations are typically written in textbook form (e.g., two dimensional mathematical notation) as:

$$\frac{{x}^{2}}{{a}^{2}} + \frac{{y}^{2}}{{b}^{2}} = cz \text{and balance} = \frac{\text{payment} * [ 1 - {( 1 + rate )}^{( month - term )} ]}{\text{rate}}$$

Debugging the calculations can be as simple as running a few sample calculations and verifying that the output is correct. However, if the output is incorrect, the debugging involves looking at the underlying formulas and verifying that they were entered correctly. This can be a difficult task where the formulas are not immediately apparent or separable from the associated data. For example, in complex spreadsheets, the formula in one cell may involve data located in different locations across several pages (e.g. sheets) of data and on the output of other formulas that also involve data spread throughout several pages of data. One major short coming of spreadsheets is that the underlying formulas are not immediately and clearly visible or separable from the associated data. That makes it harder to quickly understand the mathematical formulations on which a given set of spreadsheet calculations (e.g., the model) is based.

There therefore exists a need in the art to provide a method and apparatus that allows users the ability to visually check if the formulas were entered as intended in the programming environment.

### BRIEF SUMMARY OF THE INVENTION

In view of the foregoing and other problems, it is a feature of the present invention to provide a system that takes a formula in single line form in spreadsheets (i.e., programming environments) and converts it into textbook form (e.g., two dimensional mathematical notation). This allows the user to visually check the formulas to determine if the formulas were entered correctly. The system allows the verification to be done at the level of a single line as entered in the programming environment or to be done at the level of multiple lines by recursively substituting variables to build up a formula which may have been sub-divided for the sake of convenience or for creating intermediate formulas used in other formulas.

It is a further feature of the present invention to assign symbolic names to spreadsheet cells containing formulas and cells containing input values used by formulas in other cells from a single programming environment window. The symbolic naming gives formulas more meaning when the formulas are being debugged.

It is a further feature of the system to copy formulas displayed in textbook format into applications that support standard image formats. This provides the ability to paste formulas into word processing documents and other programs that accept standard image formats.

It is a further feature of the system to solve complicated formulas that are too complex for the programming environment to handle, too difficult to maintain or extend in the programming environment, or too time-consuming for the programming environment to execute to be executed in an independent module capable of solving the complicated formulas and have the solution linked to the programming environment.

Other features and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 illustrates a computing environment in which the present invention may operate;

FIG. 2 illustrates an engineering calculation example of a programming environment in which the present invention operates;

FIG. 3 shows a flow chart illustrating the methodology of displaying formulas in two dimensional mathematical notation in accordance with the teachings of the present invention;

FIG. 4 shows a dialog box in the programming environment of FIG. 2 illustrating the limitation of cell ranges in accordance with the teachings of the present invention;

FIG. 5a shows a dialog box illustrating cell names on the engineering calculation of FIG. 2 prior to assigning symbol names to cells containing input variables and formulas;

FIG. 5b shows the dialog box of FIG. 4a with symbolic names assigned to cells containing input variables and formulas in accordance with the teachings of the present invention.

FIG. 6 shows a dialog box in which formulas are displayed in two dimensional mathematical notation in accordance with the teachings of the present invention;

FIG. 7a illustrates the ability to view formulas in partially or fully expanded form in accordance with the teachings of the present invention;

FIG. 7b illustrates the formula shown in FIG. 7a at a depth field of one;

FIG. 7c illustrates the formula shown in FIG. 7a at a depth field of zero;

FIG. 8 illustrates a programming environment in which an independent application program is linked to provide a solution to the programming environment in accordance with the teachings of the present invention;

FIG. 9a illustrates a step in the method to link an independent application program into the programming environment of FIG. 10 in accordance with the teachings of the present invention;

FIG. 9b illustrates the step of assigning a variable in the independent application program from the programming environment of FIG. 10 in accordance with the teachings of the present invention; and

FIG. 9c illustrates the steps of obtaining output variables from the independent application program in the programming environment of FIG. 8.

While the invention will be described in connection with certain embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

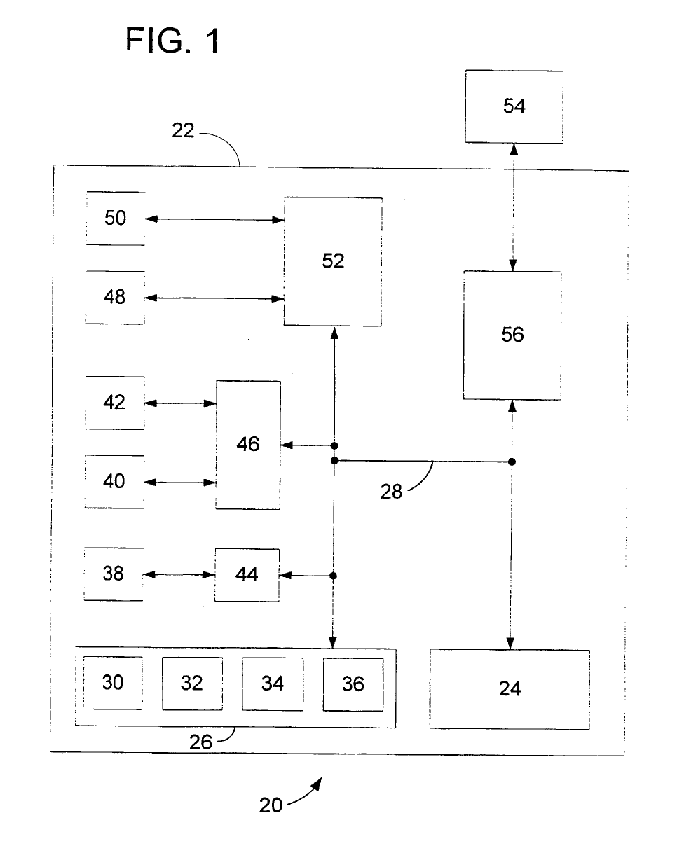

In the drawings, where like reference numerals refer to like elements, the invention is illustrated as being implemented in a suitable computer environment. Although not required, the invention will be described in the general context of computer-executable instructions, such as program modules (e.g., routines, programs, compounds etc., that perform certain tasks), being executed by a personal computer. FIG. 1 illustrates an example of a suitable computing environment 20 on which the invention may be implemented. The computing environment 20 is only one example of a suitable computing environment and is not intended to suggest any limitation as to the scope of use or functionality of the invention.

The computing environment 20 includes a general purpose computing device in the form of a personal computer 22. While FIG. 1 shows a personal computer 22, those skilled in the art will appreciate the general purpose computing device may be in the form of a hand-held device, laptop, network PC, minicomputer, mainframe computer, and the like. Components of personal computer 22 may include, but are not limited to, a processing unit 24, a system memory 26, and a system bus 28 that couples various system components including the system memory to the processing unit 24. The system bus 28 may be any of several types of bus structures using any of a variety of bus architectures such as the Industry Standard Architecture (ISA) bus, Enhanced ISA (EISA) bus, Video Electronics Standards Associate (VESA) local bus, and Peripheral Component Interconnect (PCI) bus also known as Mezzanine bus.

Personal computer 22 typically includes a variety of computer readable media that may comprise computer storage media and communication media. Computer storage media includes both volatile and nonvolatile, removable and non-removable media implemented in any method or technology for storage of information such as computer readable instructions, data structures, program modules or other data. By way of example and not limitation, computer storage media includes RAM, ROM, EEPROM, other memory technology, CD-ROM, digital versatile disks (DVD), optical disk storage, magnetic disk storage, and magnetic storage devices. Communication media is used to send computer readable instructions, data structures, program modules or other data in the computing environment 20. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 26 includes computer storage media in the form of volatile and/or nonvolatile memory such as read only memory (ROM) and random access memory (RAM). A basic input/output system (BIOS), containing the basic routines that help to transfer information between elements within computer 22, such as during start-up, is typically stored in ROM. RAM typically contains data and/or program modules that are immediately accessible to and/or presently being operated on by processing unit 24. By way of example, and not limitation, FIG. 1 illustrates operating system 30, application programs 32, other program modules 34, and program data 36.

The personal computer 22 may also include other removable/non-removable, volatile/nonvolatile computer storage media, including a hard disk drive 38 that reads from or writes to non-removable, nonvolatile magnetic media, a magnetic disk drive 40 that reads from or writes to a removable, nonvolatile magnetic disk, and an optical disk drive 42 that reads from or writes to a removable, nonvolatile optical disk such as a CD ROM or other optical media. The hard disk drive 38 is typically connected to the system bus 28 through a non-removable memory interface such as interface 44, and magnetic disk drive 40 and optical disk drive 42 are typically connected to the system bus 28 by a removable memory interface, such as interface 46.

The drives 38, 40, 42 and the like provide storage of computer readable instructions, data structures, program modules and other data for the personal computer 22, such as storing operating systems, application programs, other program modules, and program data. A user may enter commands and information into the personal computer 22 through input devices such as a keyboard 48 and pointing device 50. Pointing device 50 is typically referred to as a mouse, trackball or touch pad. These and other input devices are typically connected to the processing unit 24 through a user input interface 52 that is coupled to the system bus, but may be connected by other interface and bus structures, such as a parallel port, serial port, game port or a universal serial bus (USB). A monitor 54 or other type of display device is also connected to the system bus 28 via an interface, such as a video interface 56. In addition to the monitor, computers may also include other peripheral output devices such as speakers and a printer, which may be connected through an output peripheral interface.

In the description that follows, the invention will be described with reference to acts and symbolic representations of operations that are performed by one or more computer, unless indicated otherwise, in a manner well understood by those skilled in the art. While the invention is being described in the foregoing context, those of skill in the art will appreciate that various of the acts and operation described hereinafter may also be implemented in hardware.

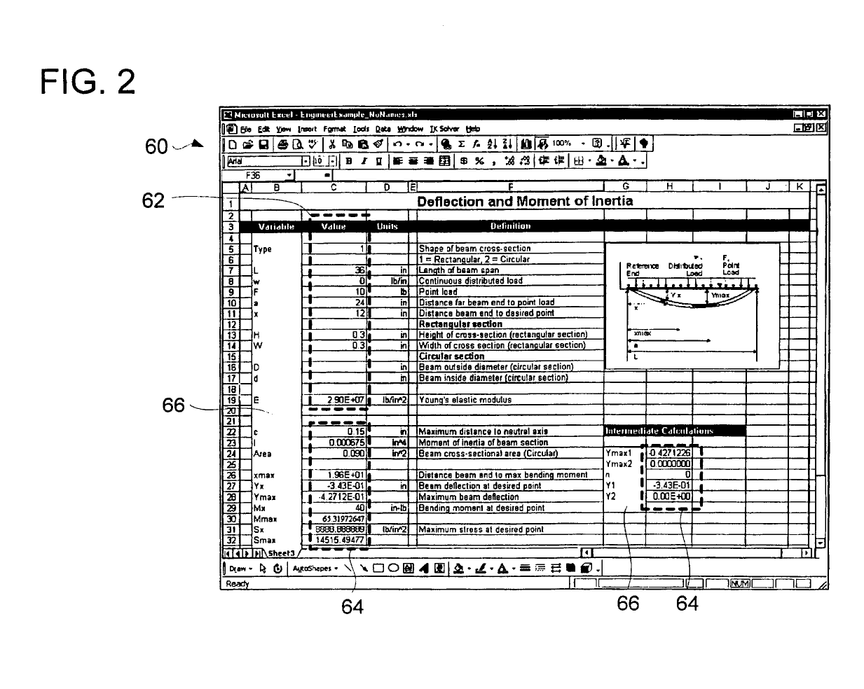

Turning now to FIG. 2, an example of a suitable programming environment 60 on which the invention may be implemented is shown. The programming environment 60 is only one example of a suitable programming environment and is not intended to suggest any limitation as to the scope of use or functionality of the invention. The programming environment 60 may be a spreadsheet program such as Microsoft Excel® and programming languages such as FORTRAN, BASIC, Visual Basic, VBA, Pascal, C, JAVA, etc. and may be part of the operating system 30, application programs 32, or program modules 34. For purposes of explanation, and not limitation, the present invention will be described in the context of an engineering model that calculates deflection and moment of inertia in a beam with either rectangular or circular cross sections. The engineering model has input values 62 (i.e., variables) and calculated values 64 (i.e., formulas). Symbolic names 66 are used to describe the variables 62 and formulas 64 in terms that users understand. For example the formula for Yₘₐₓ₁ in single line format is C9*(C7−C10)*(C26ˆ 3−C10*(2*C7−-C10)*C26)/(6*C7*C19*C23) and in single line mathematical notation is F*(L−a)*(xmaxˆ 3−-a*(2*L−a)*xmax)/(6*L*E*I).

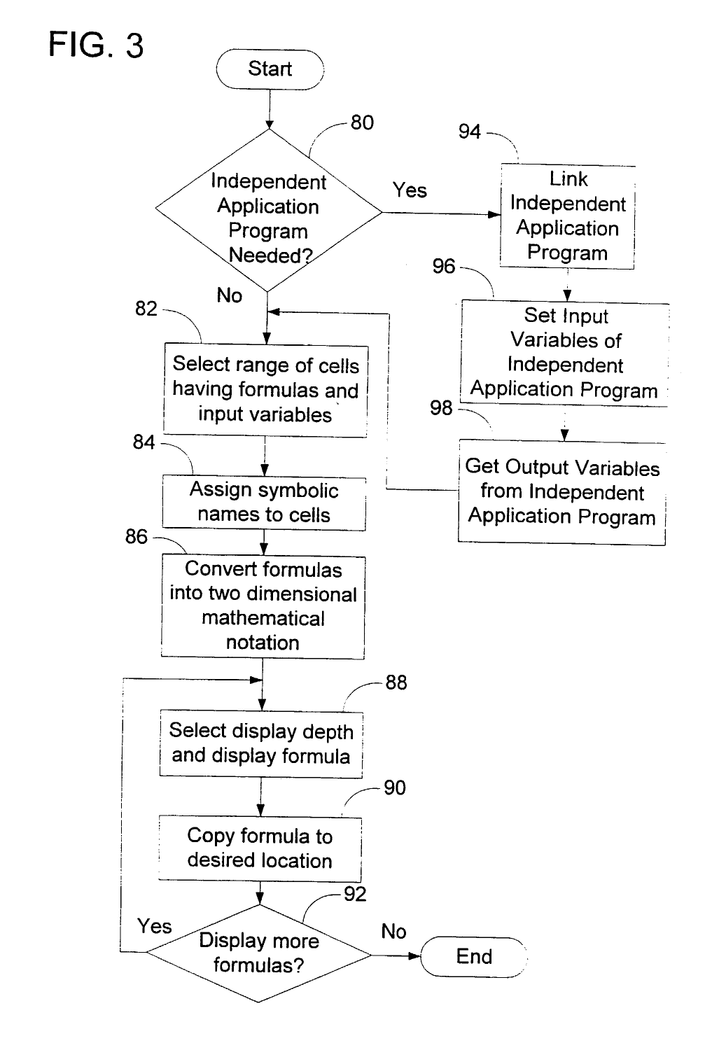

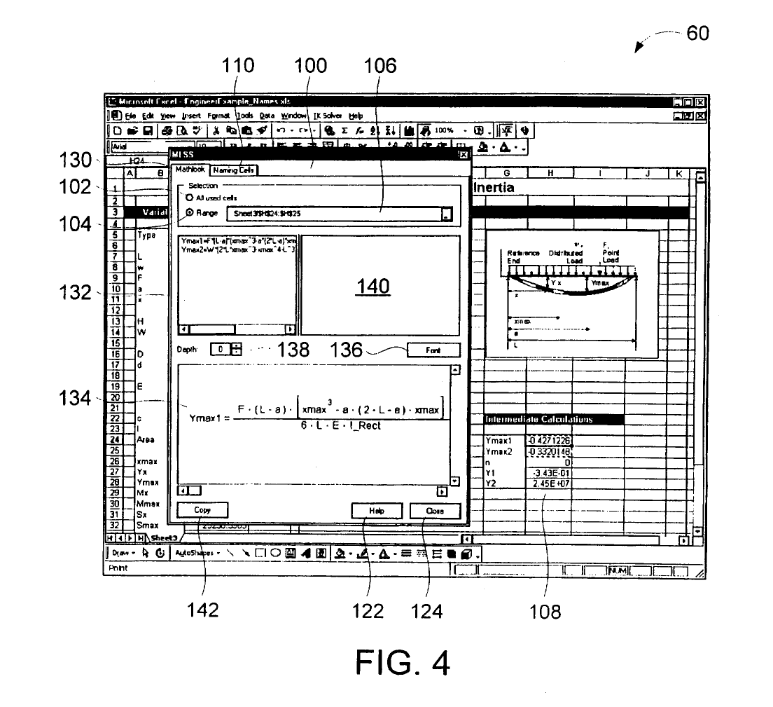

Turning now to FIG. 3, the steps taken to convert a formula in single line format are shown. Those skilled in the art will recognize that there are complicated formulas that are too complex for the programming environment to handle, too difficult to maintain or extend in the programming environment, or too time-consuming for the programming environment to execute. For these complicated formulas, an independent application program is used to solve the complicated formula. The user determines if an independent application program is needed (step 80). If the independent application program is not needed, the user selects a range of cells that the user wants to see in two dimensional mathematical notation (step 82). FIG. 4 illustrates in one embodiment how the user may select all cells having variables 62 or formulas 64 or a range of cells. To select all cells, the user opens dialog box 100 and selects the “All used cells” button 102. To select a range of cells, the user selects the “Range” button 104 and types in a range in box 106 or highlights the range on the worksheet as shown at location 108.

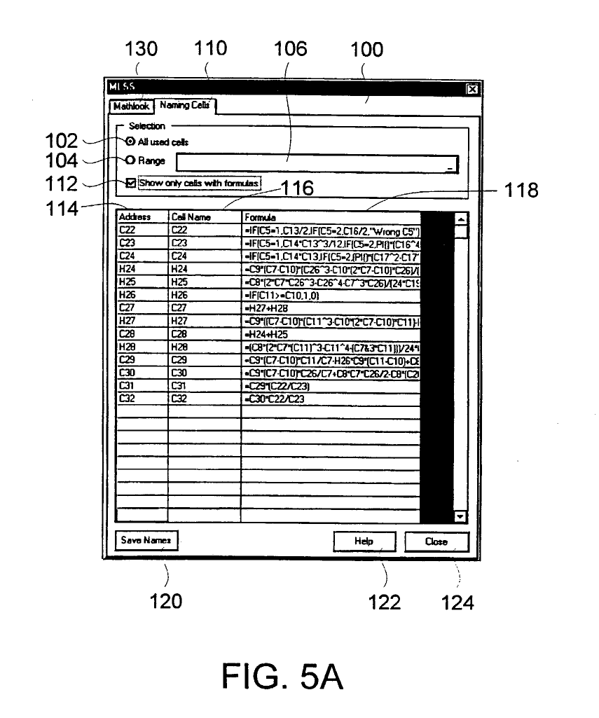

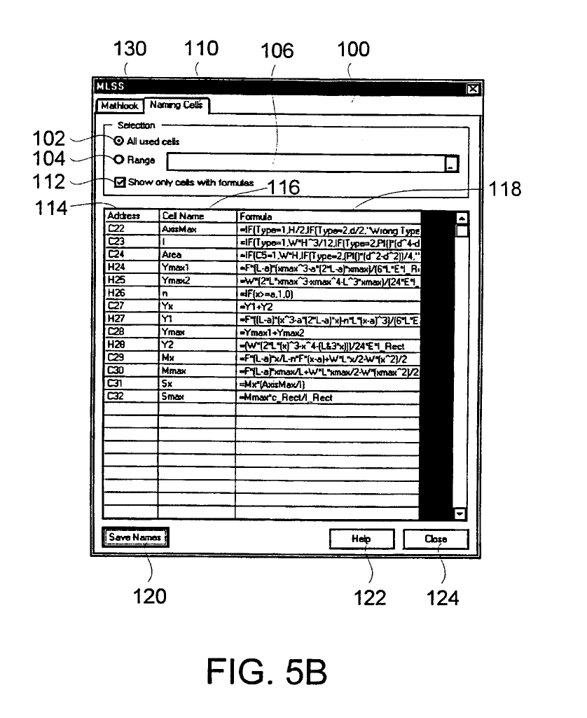

The user assigns symbolic names to cells (step 84). Symbolic naming gives formulas more meaning for purposes of documenting worksheets and debugging. FIGS. 5a and 5b illustrate in one embodiment how symbolic names are assigned. The user selects the naming cells tab 110 on dialog box 100 and selects the range of cells to which the user wants to assign symbolic names. The user may show only cells with formulas select by selecting checkbox 112. If the checkbox 112 is on, the dialog box 100 lists the formulas in the range of used cells in this spreadsheet. If the checkbox 112 is off, the dialog box shows all cells in the range of cells selected. The naming cells tab 110 has an address field 114, a cell name field 116, and a formula field 118. The formula field 118 displays formulas for the cells that contain formulas. It is recommended that the checkbox 112 should be turned off to assign symbolic names so that symbolic names can be assigned to both the cells containing formulas and the cells containing input values used by the formulas. The user types the symbolic name she wants to use in the corresponding cell name field 116. The user may also assign symbolic names to cells by changing cell references to symbolic names in the formula field 118. For example, changing the cell name for address H24 from “H24” to “Ymax1” changes all references to “H24” in formulas to “Ymax1” and changing the cell name for C9 (not shown) from “C9” to “F” changes all references to “C9” to “F” in formulas (see formulas for addresses H24, H27, C29, and C30). Once all the appropriate cells are named, the changes are saved by clicking the save names button 120. FIG. 5a shows the formulas prior to assigning symbolic names and FIG. 5b shows the formulas after all symbolic names have been assigned. While FIG. 5b shows all formulas assigned symbolic names, those skilled in the art will recognize that a subset of formulas and variables may be assigned symbolic names. The help button 122 brings up a help menu and the close button 124 closes dialog box 100.

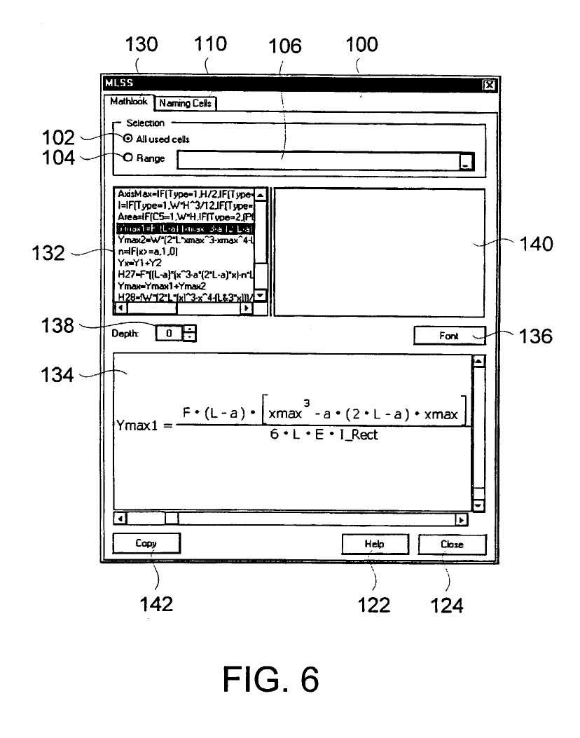

Once the symbolic names are assigned, the formulas are converted from single line format into two dimensional mathematical notation (step 86). FIG. 6 illustrates an embodiment in which the single line formula is converted. The user selects the MathLook tab 130 where the formulas are created and edited. Formulas are selected from list 132 and are displayed in window 134. It should be noted that multiple formulas can be displayed in window 134. The size, typeface and type style of the displayed formula can be changed by clicking the font button 136, which brings up a common dialog box for font selection as known by those skilled in the art.

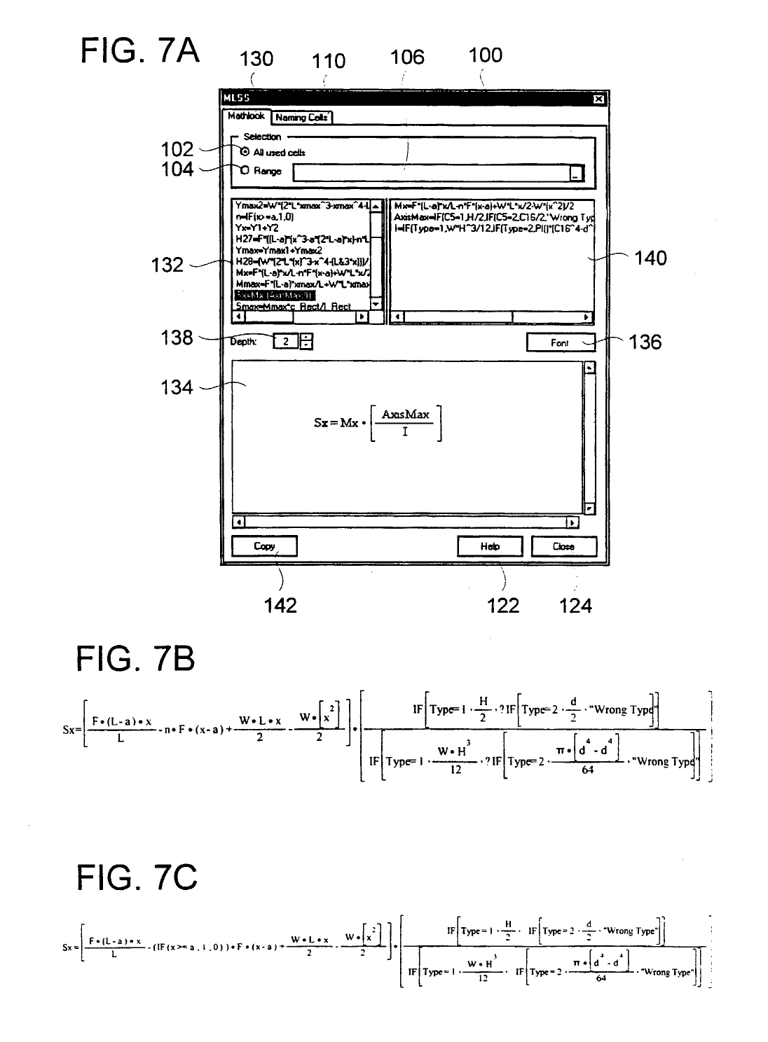

The display depth is selected by the user and the formula is displayed in two dimensional mathematical notation (step 88). When the user selects a formula whose variables depend on other formulas (e.g., an input formula), window 140 will list the other formulas (see FIG. 7a). In complex calculations, it is often helpful to view formulas in a partially or fully expanded form. The invention allows the user to recursively substitute variables with their corresponding formulas and view formulas in their expanded forms. The depth field 138 shows the levels of depth for which variables can be substituted. In order to expand or contract a formula, the user decreases or increases, respectively, the depth field 138. A depth field 138 set to zero indicates that all variables have been substituted with their corresponding formulas. For example, FIG. 6 shows a depth field of zero and FIG. 7a shows a depth field of two. FIG. 7b shows a depth field of one and FIG. 7c shows a depth field of zero.

In converting or translating the single line formatted formula into two dimensional mathematical notation format, the invention translates control characters and associated variables in the single line format into an equivalent two dimensional mathematical notation. Superscript control characters (e.g., “ˆ ” which generally indicate a power) and its associated variables are converted to a power symbol. Division control characters (e.g. “/”) are converted to division lines. Parentheses that are in certain locations within the formula may be converted to brackets. For example, Xˆ 2/yˆ 2 is translated to:

$$\frac{{x}^{2}}{{y}^{2}}$$

When the formula is displayed at the depth field desired, the formula is copied to the desired location (step 90). In the embodiment shown in the figures, the copying is performed by clicking the copy button 142. The two dimensional mathematical notation formatted formula can be pasted in any application that supports the standard metafile image format such as spreadsheets, word processing documents, etc. If the user wants to display or copy more formulas in two dimensional mathematical notation (step 92), steps 88 to 90 are repeated.

As previously mentioned, an independent application program is used to solve complicated formulas that are too complex for the programming environment to handle, too difficult to maintain or extend in the programming environment, or too time-consuming for the programming environment to execute. If the user determined that an independent application program was needed (step 80), the independent application program is linked to the programming environment 60 (step 94). The independent application program may be any program that is used to build a calculation program model solve the calculation model. For purposes of illustration, the TK Solver program by Universal Technical Systems, Inc and the Microsoft Excel® spreadsheet shall be used to explain the linking of the independent application program. Once the independent application program is linked, the input variables of the independent application program are set (step 96). The calculation program model is solved and the output variables from the independent application program are extracted into the programming environment 150 (step 98). The steps of 82-92 are then taken to convert or translate the single line formatted formulas into two dimensional mathematical notation formatted formulas.

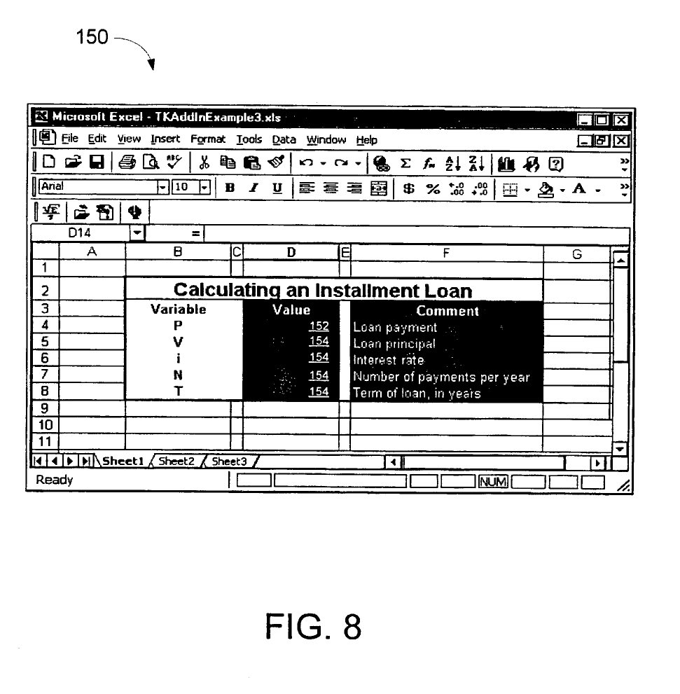

By way of example, and not limitation, FIG. 8 illustrates a programming environment 150 in which the independent application program is linked. For purposes of illustration, the independent application program will be used to compute the monthly payment on a loan. The equation to compute the monthly payment (P) on a loan amount (V) at a certain annual interest rate (i) over a certain loan term (T) is

$$P = V \cdot [ \frac{{[ 1 + \frac{i}{N} ]}^{( N \cdot T )}}{{[ 1 + \frac{i}{N} ]}^{( N \cdot T )} - 1} ] \cdot [ \frac{i}{N} ]$$

where the number of payments per year is denoted by (N). The TK Solver program model (i.e., calculation program model) can solve the model for any of the listed variables. For purposes of illustration, the formula will be solved for the loan payment P. The loan payment P will become the output variable 152, while the other variables will be input variables 154.

The independent application program is loaded and the calculation program model is linked. In order to link the calculation program model, a load model command 156 is placed in a cell in the programming environment 150. For example, the load model command 156 in one embodiment is TKSolverLoadModel(“program path”) where the program path is the path to the model on the hard drive or network. The path can be a relative path or an absolute path as known by those skilled in the art.

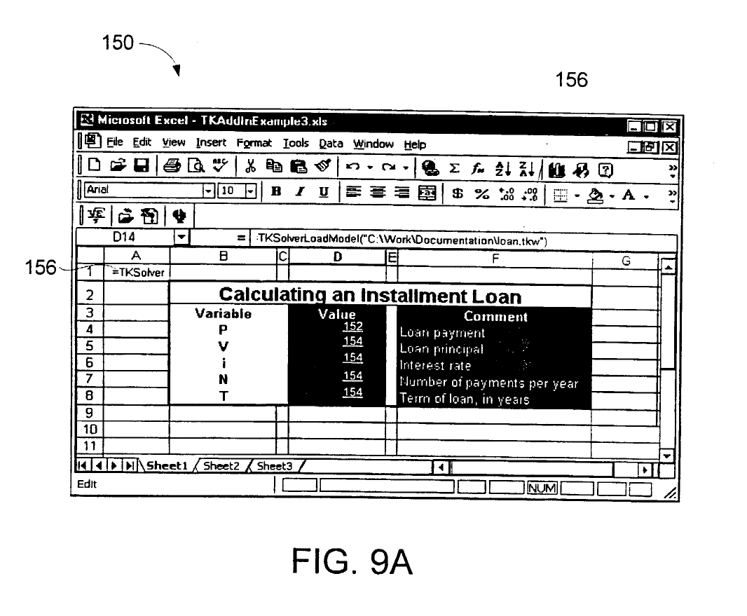

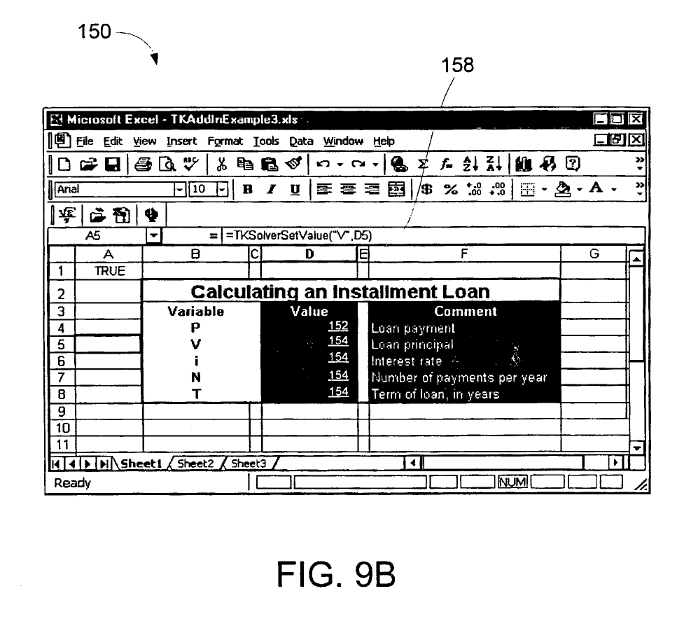

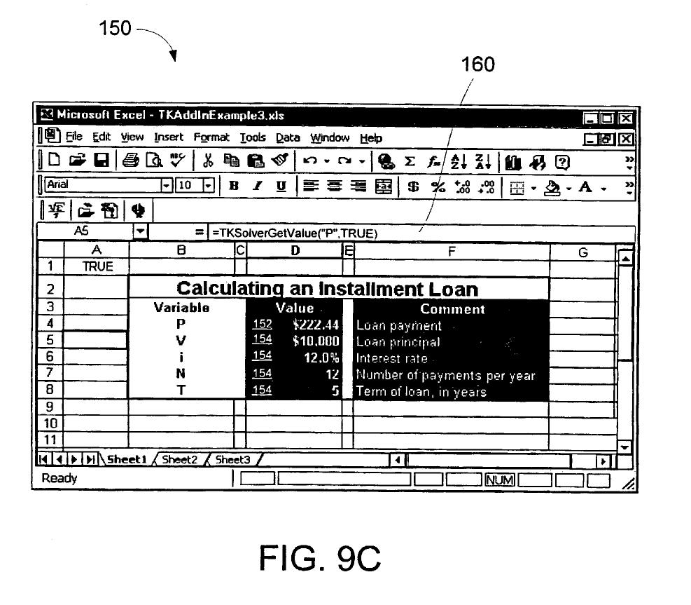

In order to set input variables from the programming environment to the independent application program, a set value command 158 is used. For example, the set value command 156 in one embodiment is TKSolverSetValue(“input variable name”, “input variable”) where “input variable name” is the name of an input variable 154 and “input variable” is the input variable 154 or the location in the programming environment 150 where the input variable 154 is located (see FIG. 9b).

In order to get variables from the independent application program, a get value command 160 is used. For example, the get value command 156 in one embodiment is TKSolverGetValue(“variable name”, “output type”) where “variable name” is the name of an output variable 152. The get value command 160 is placed in the cell where the function is located. Once the input variables 154 are entered, the output variable 152 is extracted from the calculation program model.

The programming environment uses other commands to link to the independent application program. These commands are an update command, an examine command, a get list value command, and a set list value command.

The update command is used to recalculate a solution in the independent application program and update the results of the calculation program model. In one embodiment, the update command is expressed as TKSolverUpdate. The examine command is used to calculate a function in the independent application program. In one embodiment, the examine command is expressed as TKSolverExamine(“expression”) where “expression” is the function to be calculated.

The set list value command is used to set the value of a specified element in a specified list. In one embodiment, the set list value command is expressed as TKSolverSetListValue(listname, input, index) where “listname” is the name of the list in the independent application program, “input” is the input value, and “index” is the list index to located the specified element. The get list value command is used to obtain a value of a specified element in a specified list in the independent application program. In one embodiment, the get list value command is expressed as TKSolverGetListValue(listname, index, “format”) where “listname” is the name of the list in the independent application program, “index” is the list index to located the specified element, and “format” is used to select whether the output is numeric.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of displaying a single line formatted formula located in a programming environment in a two dimensional mathematical notation format, the method comprising:
assigning a first symbolic name to the single line formatted formula;
assigning a second symbolic name to at least one data field associated with the single line formatted formula;
converting the single line formatted formula into a formula in two dimensional mathematical notation format using the first symbolic name and the second symbolic name; and
displaying the formula in two dimensional mathematical notation format.

2. The method of claim 1 further comprising the steps of:
receiving a location of the single line formatted formula; and
receiving a location of the at least one data field.

3. The method of claim 1 further comprising the step of copying the formula in two dimensional format into at least one of the programming environment and a word processing document.

4. The method of claim 1 wherein the variable in at least one data field is an input formula to the single line formatted formula, the method further comprising the step of recursively substituting the input formula into the formula.

5. The method of claim 1 wherein the variable in at least one data field is an output from a calculation program model, the method further comprising the step of linking the calculation program model to the programming environment.

6. The method of claim 5 wherein the step of linking the calculation program model to the programming environment comprises the steps of:
loading the calculation program model;
sending input values of the calculation program model;
solving the calculation program model;
extracting output values into the programming environment.

7. The method of claim 1 wherein the step of converting the single line formatted formula into the formula in two dimensional mathematical notation comprises the steps of:
replacing a data reference to the data field with the second symbolic name;
replacing a formula reference to the single line formatted formula with the first symbolic name; and
translating each control character and associated data field into an equivalent two dimensional mathematical notation data field.

8. The method of claim 7 wherein the step of translating each control character and associated data field into an equivalent two dimensional mathematical notation data field comprises the steps of:
translating a superscript control character and associated data field into a superscript formatted symbolic name; and
translating a subscript control character and associated data field into a subscript formatted symbolic name.

9. The method of claim 8 wherein the step of translating each control character and associated data field into an equivalent two dimensional mathematical notation data field further comprise the step of translating a divisor control character into a division line.

10. The method of claim 9 wherein the step of translating a divisor control character into a division line further comprises the steps of placing data fields in a numerator above the division line and placing data fields in a denominator below the division line.

11. The method of claim 9 wherein the step of translating each control character and associated data field into an equivalent two dimensional mathematical notation data field further comprises the step of translating at least one parentheses set into a bracket set.

12. A method comprising the step of displaying a single line formula in two dimensional mathematical format.

13. The method of claim 12 wherein the step of displaying a single line formula in two dimensional mathematical format comprises the steps of:
displaying a menu of at least one formula in single line format;
receiving a menu entry selection signal indicative of a user selecting one of the at least one formula, and in response to the selection signal, displaying the one of the at least one formula in two dimensional mathematical format.

14. The method of claim 13 further comprising the steps of:
displaying a menu of cells in response to a user selecting one of a range of cells and all used cells, each entry in the menu comprising an address, a cell name and a formula; and
translating an address in at least one formula in the formula field to a symbolic name in response to a user entering the symbolic name as the cell name associated with the address.

15. The method of claim 14 wherein the step of displaying a menu of cells in response to a user selecting one of a range of cells and all used cells further comprises the step of extracting formulas associated with the cells from a programming environment.

16. The method of claim 13 wherein at least one input to the single line formula is an input formula, the method further comprising the steps of:
receiving a depth selection signal indicative of a user selecting a depth, and in response to the depth selection signal, recursively substituting the input formula into the one of the at least one formula; and
wherein the step of displaying the one of the at least one formula in two dimensional mathematical format comprises the step of displaying the one of the at least one formula with the input formula recursively substituted in two dimensional mathematical format.

17. The method of claim 13 further comprising the step of:
if a variable of a formula depends on an other formula, displaying the other formula in response to a user selecting the formula.

18. The method of claim 17 further comprising the steps of:
receiving a depth selection signal indicative of a user selecting a depth, and in response to the depth selection signal, recursively substituting the other formula into the one of the at least one formula if the other formula is at the depth selected; and
wherein the step of displaying the one of the at least one formula in two dimensional mathematical format comprises the step of displaying the one of the at least one formula having the other formula recursively substituted in two dimensional mathematical format.

19. A computer readable medium having computer-executable instructions for performing the step comprising displaying a single line formula in two dimensional mathematical format

20. The computer-readable medium of claim 19 having further computer-executable instructions for performing the steps comprising:
assigning a first symbolic name to the single line formula;
assigning a second symbolic name to at least one data field associated with the single line formula; and
converting the single line formula into a formula in two dimensional mathematical notation format using the first symbolic name and the second symbolic name.

21. The computer-readable medium of claim 20 having further computer-executable instructions for performing the steps comprising:
receiving a location of the single line formula; and
receiving a location of the at least one data field.

22. The computer-readable medium of claim 21 wherein the step comprising receiving a location of the formula comprises the steps of:
displaying a menu of at least one formula in single line format, each entry in the menu comprising an address, a cell name and a formula;
receiving a menu entry selection signal indicative of a user selecting one of the at least one formula, and in response to the selection signal, setting the location of the cell to the address associated with the one of the at least one formula.

23. The computer-readable medium of claim 20 having further computer-executable instructions for performing the step comprising copying the formula in two dimensional format into at least one of the programming environment and a word processing document.

24. The computer-readable medium of claim 20 wherein the variable in at least one data field is an input formula to the single line formula, the computer-readable medium having further computer-executable instructions for performing the step comprising recursively substituting the input formula into the formula.

25. The computer-readable medium of claim 20 wherein the variable in at least one data field is an output from a calculation program model, the computer-readable medium having further computer-executable instructions for performing the step comprising linking the calculation program model to the programming environment.

26. The computer-readable medium of claim 20 wherein the step of converting the single line formula into the formula in two dimensional mathematical notation comprises the steps of:
replacing a data reference to the data field with the second symbolic name;
replacing a formula reference to the single line formatted formula with the first symbolic name; and
translating each control character and associated data field into an equivalent two dimensional mathematical notation data field.

27. The computer-readable medium of claim 20 having further computer-executable instructions for performing the steps comprising:
displaying a menu of at least one formula in single line format, each entry in the menu comprising an address, a cell name and a formula;
receiving a menu entry selection signal indicative of a user selecting one of the at least one formula, and in response to the selection signal, displaying an other formula if a variable of the one of the at least one formula depends on an other formula in response to a user selecting one of the at least one formula; and
wherein the step of displaying a single line formula in two dimensional mathematical format comprises the step of displaying the one of the at least one formula in two dimensional mathematical format.

28. The computer-readable medium of claim 27 having further computer-executable instructions for performing the steps comprising:
receiving a depth selection signal indicative of a user selecting a depth, and in response to the depth selection signal, recursively substituting the other formula into the one of the at least one formula if the other formula is at the depth selected; and
wherein the step of displaying the one of the at least one formula in two dimensional mathematical format comprises the step of displaying the one of the at least one formula in two dimensional mathematical format with the other formula recursively substituted into the one of the at least one formula.
